(19) United States
(12) Patent Application Publication
(10) Pub. No.: US 2006/0292535 A1
(43) Pub. Date: Dec. 28, 2006

(54) DISEASE TREATMENT SIMULATION

(76) Inventors: Patrick O'Connor, Minneapolis, MN (US); George Biltz, St. Paul, MN (US); Pradyumna (Autri) Dutta, Sleepy Hollow, NY (US); Paul E. Johnson, Minneapolis, MN (US); William Rush, Minneapolis, MN (US); JoAnn M. Sperl-Hillen, Minneapolis, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/379,351

(22) Filed: Apr. 19, 2006

Related U.S. Application Data
(60) Provisional application No. 60/672,890, filed on Apr. 19, 2005.

(51) Int. Cl. G09B 23/28

(52) U.S. Cl. 434/262

(57) ABSTRACT

A method of dynamically simulating a physician assessment and teaching environment for treatment of a chronic illness is provided. The method includes providing a library of patient cases histories, selecting a patient case history from the library of patient case histories, providing a treatment action in response to the particular patient case history selected, and providing a projection of the patient's future clinical status based upon the treatment action provided.

### CROSS REFERENCE TO RELATED APPLICATIONS

This application claims priority to U.S. provisional application Ser. No. 60/672,890, filed on Apr. 19, 2005, which is incorporated herein by reference.

### TECHNICAL FIELD

The inventive subject matter relates to simulation software and, more particularly, to disease treatment simulation.

### BACKGROUND

The clinical course of chronic illnesses such as diabetes mellitus type 2 is generally characterized by slowly changing states of health, with inherent variability in the rate of disease progression across patients. The detection of significant change in health status of individual patients may be masked by the subtle progression of the disease and its complications, and of common comorbid conditions. Physicians often fail to prescribe appropriate evidence-based treatment in patients who have not achieved recommended clinical goals for a variety of reasons. There are several confounding variables that affect patients' response to treatment. For example, changes in socioeconomic status or health insurance coverage may alter patterns of care or medication adherence.

The cognitive challenges to physicians caring for those with a complex chronic disease such as diabetes are many. Some of the major cognitive tasks include—
Selecting appropriate evidence-based clinical goals across multiple clinical domains (for example, glucose, blood pressure, cholesterol).
Initiating appropriate therapy.
Titrating therapy to achieve and maintain desired evidence-based goals.
Detecting and effectively managing comorbid conditions, such as depression, that may interfere with diabetes treatment.

Computer-based models and simulation methods have been used to better understand and improve diabetes care. Diabetes Physiolab™ is a proprietary system that models disease at the level of enzymatic activity. Other efforts have modeled general diabetes physiology (Sarimner), pharmacokinetics, specific glucose-insulin interactions as educational simulators (AIDA, DIABLOG), as well as diabetes decision-support systems (DIAS-NIDDM). The Global Diabetes Model, a stochastic model of type 2 diabetes, has been developed to predict trends for diabetic individuals or populations. A recent model—Archimedes—has simulated a continuous disease process at the individual patient level. Other case-based learning efforts exist that are used for physician continuing education.

However, existing models do not provide dynamic feedback or learning where the long-term effect of previous moves can be represented. They also do not provide a focus on the clinical encounter, which is the basis for the study and improvement of physician decision-making.

### SUMMARY

In accordance with an embodiment, a method of dynamically simulating a physician assessment and teaching environment for treatment of a chronic illness is provided. The system and method includes providing a library of patient cases histories, selecting a patient case history from the library of patient case histories, providing a treatment action in response to the particular patient case history selected, and providing a projection of the patient's future clinical status based upon the treatment action provided.

### THE BRIEF DESCRIPTION OF THE DRAWINGS

The present disclosure will become better understood with reference to the following description and accompanying drawings, wherein:

FIG. 1 is a diagram illustrating the physician interaction with the simulation according to one embodiment of the present invention;

FIG. 2 is a diagram illustrating various attributes of the simulation according to one embodiment of the present invention;

FIG. 3 is a flow chart illustrating the various functions in the patient model according to one embodiment of the present invention; and

FIG. 4 is a graphical representation of dose and duration of medication according to one example of one embodiment of the present invention.

### DETAILED DESCRIPTION

The software and methods described herein provide a dynamic and interactive simulation environment for the treatment of patients with type 2 diabetes. A set of outpatient cases is presented in sequence. Each case is managed through a series of virtual patient-physician encounters in a primary care clinic setting. The physician is able to perform the traditional subjective-objective-assessment plan (SOAP) approach to patient care. This format helps establish clinical plausibility and provides a framework for presenting data and accepting treatment moves. (Each treatment action made by the subject physician through the interface is a “move.”)

The simulation is an abstraction of the type 2 diabetes clinical setting, created for purposes of capturing physician treatment decisions. The goal of the simulation is to engage physician decision making and solicit representative treatment moves. Given this focus on the clinical encounter, the simulation does not incorporate a complete model of diabetic pathophysiology.

The simulation begins with the selection of a patient case from a library of cases. Each case is presented in the form of a patient case history, with initial encounter data. The case data is composed of a set of attributes (variables) that change as a function of physician moves. In each encounter, the simulation moves through a cycle composed of presentation of patient data, collection of treatment moves, and generation of new patient data in response to moves. At the conclusion of each encounter, the physician schedules a subsequent visit. The simulation responds by presenting a new encounter with updated patient information. The update of the patient information is based on both the physician moves and on the amount of elapsed time. A unique disease trajectory, which depends on the specific series of moves made by the physician, unfolds for each simulated patient.

System Components

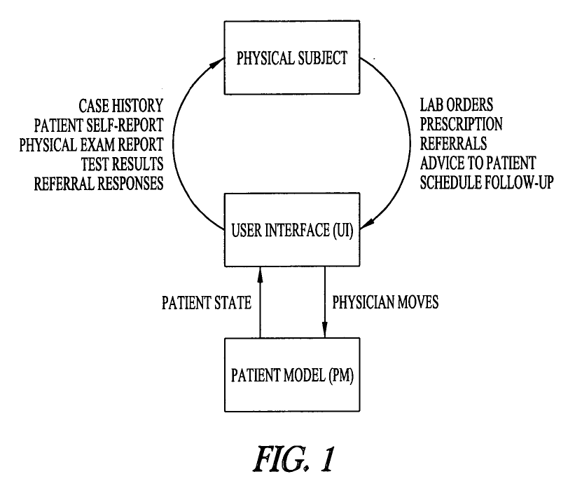

The simulation software according to one example embodiment of the inventive subject matter has two parts: (1) a user interface (UI) that presents the patient state information and accepts physician moves, and (2) a patient model (PM) that updates the patient state in response to the treatment moves and the passage of time (FIG. 1). The UI provides the environment of a clinical encounter. The PM generates information needed by the physician to make decisions with respect to treatment moves.

The User Interface (UI)

The UI presents patient data to the physician, transmits physician moves to the patient model, and preserves the clinical environment of continuous care over the encounters during which the patient is treated. There are two requirements of the UI: (1) the presented patient data must be organized and displayed in formats familiar to physicians, and (2) the physician should be able to make treatment moves in a familiar and acceptable manner.

The UI allows the physician to view patient information, including the physical exam report, recent lab results, current prescriptions, and a patient self-report. Explicit physiological data (such as blood pressure, glycated hemoglobin [HgbAlc], or a lipid panel) is provided in the physical exam report and laboratory results. Implicit behavioral (diet, exercise) and psychosocial information (adherence, depression) is provided through a patient self-report. The physician may change medications, give advice to the patient, order laboratory tests, and make referrals to specialists. At the conclusion of each encounter, the physician can schedule a subsequent visit.

A medication order form consists of a formulary and an insulin order matrix that allows the physician to prescribe different types of insulin at specific times of the day. A referral order form and laboratory test order form are modeled on those used in a large medical group practice. The physician is able to give advice to the patient on diet and exercise.

Treatment moves made by the physician are collected by the UI and sent to the patient model, which responds with an updated patient state. The new patient state information is sent to the UI and presented to the physician in the next encounter in the form of reports comprised of (1) a subjective patient self-report, (2) an objective physical exam report, (3) a self-monitored blood glucose (SMBG) log, (4) laboratory test results, and (5) referral response (if appropriate).

The Patient Model (PM)

The PM is comprised of patient state attributes and a set of functions that update values of these attributes in response to physician moves. The PM takes into account the passage of time, i.e., the patient state update is contingent upon the time elapsed between encounters, in addition to the physician moves. Patient state attributes are grouped into physiological, psychosocial, and behavioral categories. The physiological attributes specify the physiological condition of the patient, while the behavioral attributes specify the current patient self-care behaviors. The psychosocial attributes affect patient compliance with prescriptions and physician recommendations.

The Patient State

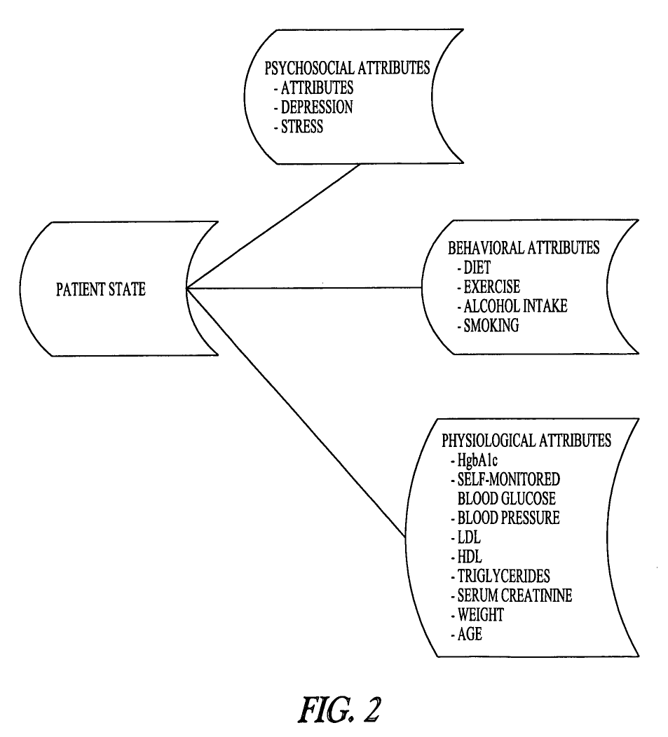

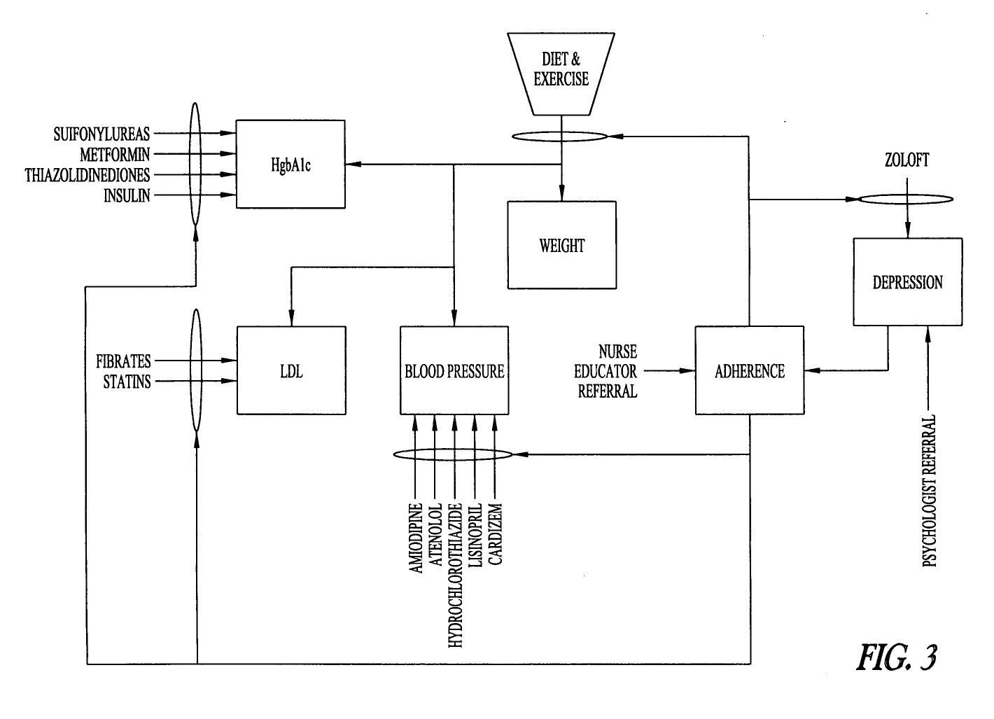

The set of physiological, behavioral, and psychosocial attributes that comprise the patient state in the PM are shown in FIG. 2. The physiological attributes change with respect to time and in response to physician moves. The selection of attributes is based on clinical treatment logic, as reflected in recent clinical guidelines and clinical literature regarding type 2 diabetes mellitus.^{10, 11} These attributes are key features in primary care management of patients with diabetes and collectively address common sources for physician errors:¹²
Insufficient awareness and treatment of cardiovascular risk factors.
Confounding effects of depression on adherence to treatment regimen.¹³
Complications from drug therapies.¹⁰
   The adherence attribute, which determines the extent to which the patient takes prescribed medications and follows physician recommendations for self-care, reproduces the effect of variation in patient compliance on patient behavior. The effect of the adherence attribute is modeled by giving the simulated patient a proportion (a value between 0 and 1) of a given prescription, as specified by the adherence value. For example, a patient prescribed Glipizide (20 mg q.d.) who has an adherence of 0.5 will only take 20*0.5=10 mg q.d. The patient follows the recommended diet and exercise to the extent dictated by the value of adherence. The effect of adherence as a moderator on all inputs to the functions in the PM is shown in FIG. 3. Depression, common among patients with diabetes,¹³ is one of the factors that adversely affect patient adherence to medication and self-care behavior regimens.¹⁴ A patient self-report provides a narrative in each encounter that describes self-care behaviors and depression symptoms, if any. Patient adherence and depression are inferred from the narrative.
   Physiological Functions

Every physiological attribute has an associated physiological function that updates its value. The inputs to a function consist of factors that affect the value of the attribute, and the output is the new attribute value. For example, the inputs to the HgbAlc function are current values of diet, exercise, and doses of sulfonylureas, Metformin, thiazolidionediones (TZD), and insulin:
New HgbAlc=f (HgbAlc, diet, exercise, sulfonylureas, Metformin, TZDs, insulin)

As shown in FIG. 3, each function sums the contribution of multiple physician moves, and time, to compute the new value of the attribute. The magnitude of the contribution of each move is specified by the magnitude of the move (e.g., drug dose), and its timing (when it is given). The former is computed using a dose-response table (specifying the magnitude of the effect), while the latter is computed using a dose-response schedule (specifying the attenuation of the medication effect over time).

Dose-response table. The dose-response table computes the maximum expected benefit of a given move, as well as the incremental benefits of titrating (adjusting) the move. In the case of medications, a dose-response table specifies the expected impact on the attribute that the drug affects at different dosages. There is a dose-response table for each drug move and the attribute that it affects, which was adopted from the Staged Diabetes Management Handbook.¹ For instance, as diet influences weight, blood pressure, and blood glucose, the dose-response tables for diet are diet-weight, diet-blood pressure, and diet-blood glucose.

The dose-response table is implemented as a sum that computes the effect of a Given move. The utility of the additive form is that it can be positive or negative, depending upon the direction of the dose change, and is able to represent the bidirectional effects of incremental dose changes at any dose level. The general form of the function representing a dose-response table is

$$Δ {Attribute}_{Drug} = Sgn ( {m}_{0} - {m}_{1} ) * {\sum }_{i = 0} {α}_{i} * max ( min ( {Dose}_{i + 1} , max ( {m}_{0} , {m}_{1} ) ) - max ( {Dose}_{i} , min ( {m}_{0} , {m}_{1} ) ) , 0 ) where {m}_{0} = current drug dose , {m}_{1} = last drug dose , and$$

$$Sgn ( x ) = - 1 if x is negative , 1 if x is positive , 0 if x = 0$$

Dose-response schedule. The effect of a move made by a physician on patient state changes over time.¹ From the time that a move is made, the effect of the move increases gradually until its time of peak effect, when the entire effect of the move is manifest on the target patient variable. The proportion of the move's effect commensurate with the amount of time elapsed is computed as the patient's response to the change in treatment. This is accomplished in the PM by using a time coefficient that specifies the proportion of the effect.

Each move available in the simulation has an associated dose-response schedule that specifies the proportion of the move's effect that depends on the time elapsed since the move was made. Some moves reach their peak effect in a few days; others can take several weeks before the entire effect is manifest. The general form of the function that approximates the proportion of the drug effect as a result of time attenuation is

$${t}_{n} = α * {( 1 + {ⅇ}^{\frac{- T}{β}} )}^{- 1}$$

where n is the number of days till peak effect, T is actual time elapsed, and a and fi are coefficients that determine the desired shape of the curve. The following functions are used for drugs that reach peak effect in 14 days and 90 days, respectively:

$${t}_{14} = 2 * {( 1 + {ⅇ}^{\frac{- T}{2}} )}^{- 1} and {t}_{90} = 2 * {( 1 + {ⅇ}^{\frac{- T}{16}} )}^{- 1} .$$

The simulated patient is updated from one encounter to the next. The incremental difference is computed by subtracting the total effect of a move on the current encounter from the total effect until the last encounter. The dose-response function facilitates this computation with the functional form

$$Δ {t}_{n} = α * [ {( 1 + {ⅇ}^{\frac{- ( Today - {doseDate}_{i} )}{β}} )}^{- 1} - {( 1 + {ⅇ}^{\frac{- ( LastVisitDate - {doseDate}_{i} )}{β}} )}^{- 1} ]$$

where Today is the date of current encounter, LastVisitDate is the date of last encounter, and doseDateᵢ is the date of move for all moves i=0..n

The incremental effect of a move at a given time is computed by multiplying the output of the dose-response table with the output of the dose-response schedule. The clinical impact of various drugs on HgbAlc, low-density lipoproteins (LDL), or blood pressure (BP) is modeled using published pharmacokinetic data.^{15, 16}

Psychosocial Functions

The effect of adherence on physiological variables is modeled using psychosocial functions for adherence and depression. The inputs to the PM function that updates adherence are (1) current adherence, (2) depression, (3) nurse educator referral (if any), and (4) dietitian referral (if any). The inputs to the depression function are (1) current level of depression, (2) psychologist referral (if any), and (3) medications (i.e., Zoloft®).

Psychosocial functions are modeled using fuzzy logic, which allows quantification of linguistic variables. Psychosocial attributes of stress and depression are described with verbal modifiers: “low,” “medium,” and “high.” The relationships between the psychosocial attributes are described linguistically—e.g., “If stress is high, then blood pressure increases” and “If depression is high, then adherence is low.” The four-step method described by Kosko in 1993 was used for computing adherence from depression and stress:¹⁷
1. Fuzzification. Develop a membership function to map the verbal description of variable (low, medium, high) to a numeric scale.
2. Rule base. Express each relationship between an independent psychosocial variable, such as depression, and a dependent variable, such as adherence, in a fuzzy rule. For example, “IF High Depression THEN Low Adherence.”
3. Inferencing. Compute the fuzzy value (set membership) of the dependent variable by using the value of the independent variable and the fuzzy rules.
Defuzzification. Convert the fuzzy value of the dependent variable to a specific numeric value. We use the “centroid” method of defuzzification in which the center of mass provides the crisp value. The center of mass is calculated by first treating each output set as a point mass, and then calculating the center of gravity for those point masses distributed along the “x” axis. We then find the center of gravity of the output point masses using the formula
   sum of the moments÷sum of the masses.
This method favors the rule with the greatest area as contrasted with the alternative “height” method, which takes the value of the biggest contributor.

Adherence changes nonlinearly in response to the combined effects of stress and depression. In one case, a cycle in the psychosocial functions causes reinforcing effects of changes between depression and adherence (FIG. 3)—creating a “virtuous circle.” When depression is treated with medication, it improves adherence, which in turn increases the amount of depression medication that is taken, improving depression further. In another case, the patient adherence could drop after depression symptoms have been resolved. The self-report patient narrative is generated in the UI by a look-up table that contains statement modifiers for low, medium, or high levels of adherence and depression.

Example Implementation

The simulation is implemented through (1) a UI programmed in Visual Basic™, (2) an Access™ relational database (DB), and (3) a rule-based engine that embodies the PM. The DB stores the patient case library, historical and current patient state information, and a record of physician moves. The simulation begins with loading a patient case from the case library into the UI. At this start point, the DB consists of only the initial encounter information for each patient in the case library. The DB is updated with subsequent encounters as the simulation progresses. The UI and rule-based engine were developed using Visual Basic to allow rapid initial prototyping through an object-oriented interface, and ease of interfacing with the Access database application.

Validation and Verification

Validation has been defined by Law as “the process of determining whether a simulation model is an accurate representation of the system, for the particular objectives of the study.”¹⁸ According to one example embodiment, one objective of the system described herein was to represent a virtual clinical encounter for patients with type 2 diabetes and to achieve sufficient clinical plausibility that representative patient management actions would be elicited.

According to one example embodiment of the system described herein, Sargent's definition of model verification is used: “ensuring that the computer program of the computerized model and its implementation are correct.”¹⁹ Software constructs such as object-oriented programming and program modularity were used to reduce implementation error. Both static “structured walk-throughs”¹⁸ and dynamic testing were performed as a part of the model verification process. Structured walk-throughs were performed with an expert physician panel at two levels—with the conceptual model to validate the simulation's representation (described below), and with the programmed simulation to verify the computer model implementation.

Conceptual, Operational, and Face Validity

Conceptual validity addresses the question of how well the components of the model and their interactions represent the phenomenon under investigation—in this case, the clinical encounter. The conceptual model of the clinical encounter and the key patient variables in the treatment of type 2 diabetes, in the model described herein, are based on clinical treatment guidelines (Institute for Clinical Systems Integration [ICSI]), the Staged Diabetes Management, and the American Diabetes Association (ADA).^{1, 10, 11} The physiological responses in the PM are based on clinical literature¹⁵ and the documented effect of psychosocial factors and their impact on treatment.^{20 21} A panel of expert physicians stepped through the process of managing an encounter in the conceptual model description to determine if the representation of the clinical encounter was appropriate for use in the system described herein. The system UI design was based on common formats of receiving information and taking action familiar to the physicians (medication order form, laboratory test order form, referral order form, physical exam report, etc.).

Operational validity determines if the model's output “has the accuracy required for the model's intended purpose over the domain of its intended applicability.”¹⁹ Model responses were studied to determine if they were
Within valid clinical bounds.
Robust to extreme or multiple inputs.
Sensitive to small changes in the input.

These questions were addressed using “extreme condition tests,” in which the model output was examined for extreme and unlikely combinations of values. In addition, “degenerate tests,” which involve the degeneracy of the model's behavior, were performed. The tests conducted on the system and model that involved changing the values of the model inputs in small and large increments to determine the effect on outputs are referred to as “parameter variability-sensitivity analysis.” The PM response to these series of experiments were graphed and reviewed by the panel of consulting physicians.

Face validity, defined by Sargent as “asking people knowledgeable about the system whether the model and/or its behavior are reasonable,”¹⁹ was deemed sufficient for the purpose of generating plausible patient responses.

Experimental Data

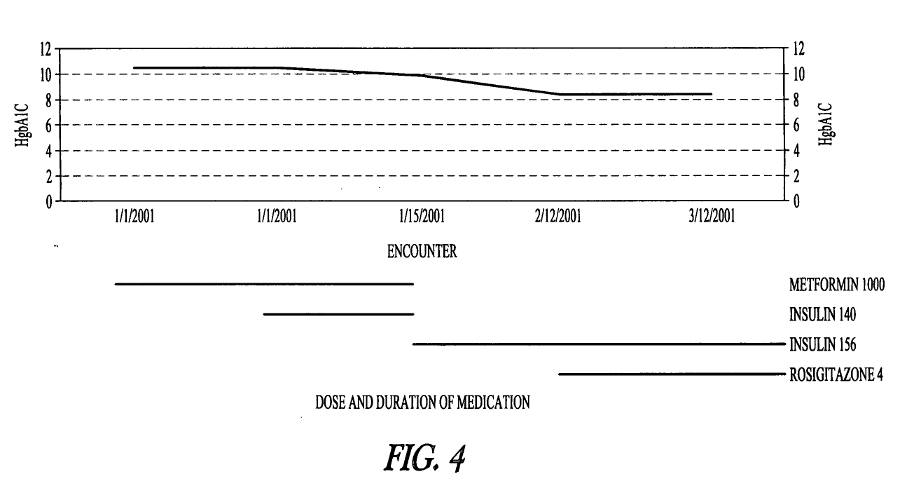

According to one example embodiment, the system presented herein was required to fulfill the primary criterion: “Can it be used by physicians to make decisions on patients who are portrayed in clinical contexts?” The patient response had to be plausible not just for a particular physician move, but for a series of moves. Table 1 shows a summary of experimental data for one subject, and FIG. 4 is a graph of the subject's moves that is available as a followup to the experiment. Table 1 has three sections: (1) lab test orders and referrals, (2) medication moves, and (3) the patient's state. Each column shows a physician-patient encounter. The table entries show the time stamp in parentheses for when a move was made. For example, “*(327)” in the first encounter (Lab Orders section/TSH_Order row) indicates that a measurement of thyroid stimulating hormone was made 327 seconds into the case. The physician subject is able to view only those patient state variables for which a test was ordered. Depression and adherence are conveyed through the patient response and self-report narrative.

TABLE 1
Experimental data: decision graph of a physician's treatment of a case
Decision Graph for Physician 5X

| | |
|---|---|
| PtntId | 16 |

| | Visit Number | | | | |
|---|---|---|---|---|---|
| | 0 (Initial data) | 1 | 2 | 3 | 4 |
| Encounter Date | | 01/01/2001 | 01/15/2001 | 02/12/2001 | 03/12/2001 |
| Visit Type | | Visit | Visit | Visit | Phone |
| Lab Orders | | | | | |
| HgbA1c | | v(94) | v(735) | v(885) | |
| SMBG | | v(481)*(529) | v(600) | v(1000) | v(1079) |
| Creatinine | | v(98)*(311) | v(740) | v(891) | |
| Lipids | | v(95) | v(737) | | |
| ALT | | *(309) | | | |
| TSH_Order | | *(327) | | | |
| UMACR | | *(332) | | | |
| CPK | | *(314) | | | |
| GL | | *(337) | | | |
| Referrals | | Psych, DE, Opth, Diet | Endo | | |
| Meds | | | | | |
| Aspirin | | 325q.d.(228) | 325q.d. | 325q.d. | |
| Atorvastatin | 20q.d. | 40q.d.(217) | 40q.d. | 40q.d.(980) | |
| Hydrochlor | 25q.d. | 0q.d.(291) | | | |
| Lisinopril | | 10q.d.(299) | 10q.d. | 10q.d. | |
| Metformin | 500b.i.d. | 500b.i.d. | 0b.i.d.(771) | | |
| Rosiglitazone | | | | 4q.d.(956) | |
| Zoloft | | | 50q.d. | 50q.d. | |
| Insulin | 75R 60N | 75R 65N(485) | 81R 75N(681) | 81R 75N(1015) | 81R 75N(1090) |
| Patient State | | | | | |
| A1c | 10.5 | 10.5 | 9.9 | 8.3 | 7.4 |
| Avg. SMBG | 267 | 261 | 229 | 165 | 146 |
| Adherence | .5 | .5 | 1.0 | 1.0 | 1.0 |
| LDL | 157 | 157 | 139 | 120 | 117 |
| HDL | 28 | 27 | 30 | 32 | 33 |
| Triglycerides | 380 | 380 | 332 | 263 | 252 |
| Systolic | 150 | 153 | 138 | 131 | 131 |
| Creatinine | 1.5 | 1.5 | 1.8 | 1.9 | 1.9 |
| Depression | 60 | 60 | 30 | 0 | 0 |

Legend: * = Lab Order, v = View Lab Values, DE = Diabetes Educator, Diet = Dietician, Opth = Ophthalmologist, Pod = Podiatrist, Psych = Psychiatrist. The number in parenthesis indicates the time stamp of the move. (All dosages are qd unless otherwise noted.)

FIG. 4 shows a graph of the patient HgbAlc response to physician moves. Similar graphs are available for lipids and blood pressure. In the project for which the simulation was developed, 40 physicians treated a set of simulated patients using the model described herein.

Summary and Conclusion

Thus, as described above, the UI depart described herein may depart from the actual encounter environment, as it may remove some of the barriers faced in actual encounters and provide an ease of performing moves that is not found in actual care. Second, a computer simulation such as that described herein may be unable to replicate the wealth of information that the physician gathers from a conversation and face-to-face meetings with a patient. In the simulation system presented herein, the physician is limited to behavioral recommendations to the patient and a patient self-report. Third, the simulation system's abstracted encounter minimizes the reality of potential psychosocial and economic barriers to care that patients face in reality.

Despite these limitations, the simulation system described herein has a variety of potential applications. First, the information obtained can be a powerful tool in the effort to identify appropriate moves, as well as errors, in the care of adults with diabetes. It is possible to map a given physician's decision processes with respect to diabetes care, and identify both specific strengths and opportunities for improvement in the core cognitive tasks that underlie decisions regarding chronic disease care.

Examples of problems uncovered by analysis of the case management data from the simulation system include failure to recognize comorbid depression (as indicated by lack of treating depression in instances where the patient is not responsive to treatment and self-reports depressive symptoms); inability to initiate insulin when necessary; failure to titrate insulin as appropriate; failure to recognize evidence-based goals for HgbAlc, BP, or lipid control; and lack of familiarity with common contraindications to the use of medications (such as Metformin).

Physician performance on the simulation system cases can also be used to guide learning interventions tailored to a given physician's patterns of care. Thus, if one physician demonstrates underuse of therapy such as insulin, teaching cases that emphasize key aspects of insulin treatment may be provided as a learning intervention for that physician. Likewise, physicians who habitually miss the diagnosis of comorbid depression can receive learning interventions that help develop that skill.

With additional development, cases in the simulation system could be used proactively with physicians early in their professional careers, to guide the development of core competencies in chronic disease care. The cases were given, as a pilot study, to a series of family practice residents and faculty who were able to recognize the value of the simulated case management as a powerful clinical teaching tool. The relevance and potential application of such learning tools may increase due to statutory limits imposed on residency training hours and the need to supplement “real” patient care experiences with high-volume, “simulated” cases with embedded teaching points.

Finally, the model now includes measures of resource use linked to visits, prescriptions, tests, and referrals. These measures enable physicians to receive feedback on the ratio of clinical benefit to resource use engendered for specific patterns of diabetes care. This may lead to recognition by individual physicians of inefficient patterns of resource use in diabetes care. A further extension would be to use the model to simulate the costs of various diabetes care protocols across populations of diabetes patients.

According to still another example embodiment, the simulation system according to the inventive subject matter described herein is a computerized tool that is designed to improve physician decision-making behavior in managing patients with chronic diseases (the prototype covers diabetes, hypertension, hyperlipidemia and depression). According to this embodiment, the system is comprised of three parts: 1) a computer interface that simulates the electronic medical record in an outpatient clinical care setting, 2) a simulated patient with type 2 diabetes that responds dynamically to treatment moves over a series of simulated encounters, and 3) a feedback interface that provides the learner with a text-based evaluation of moves made at the current encounter, suggestions for future moves, plus a graphical projection (out to 180 days) of the patients estimated response to treatment moves made thus far. In addition, the simulation system further includes the ability to simulate the use of an electronic medical record in diabetes management in the office-practice setting. Further, according to one example embodiment, the simulation system uses a case generator to present physicians with simulated cases that represent real clinical situations covering a variety of potential clinical challenges and common medical errors. Once a simulated clinical case is initiated, the physician learner selects treatment options (termed “moves”) from an unguided set of choices similar to those available in routine office practice. The patient responds dynamically in continuous time to the move sequence. In each encounter the patient embodies the effects of all the moves made in previous encounters. The system provides for comments on moves made and suggestions for future moves are made following each encounter. This is followed by a graphical projection of the effect of moves made on a standard set of patient state variables (e.g., blood glucose, lipids and blood pressure) out to 180 days.

In this example embodiment, the simulated patient incorporates both physiological and psychosocial patient responses. The psychosocial responses are computed through the novel use of fuzzy logic techniques. As in the embodiments described hereinabove, numerical methods are used to compute patient physiological responses. The representation of cumulative and incremental effects of different drugs in continuous time, and attenuation of their effects over time on patient physiology, is used by the system. Further, the system may be implemented through an advanced programming interface (API) that allows for communication with other programs as well as the creation of multiple instances of a simulated patient.

Thus, the present embodiment may function both as a physician assessment tool and a teaching and learning tool that enables the improvement of clinical decision-making in the practice setting. The system can be used to diagnose physician management deficiencies as well as a propensity to make medical errors. It can also examine the effects of particular treatment strategies, health-care policies, or guideline recommendations on particular patients or patient populations. It has potential applications in the pharmaceutical industry to tech physicians how to use new drugs safely, in accountability organizations to assess physician knowledge and customize leaning recommendations, as well as in quality improvement and continuing medical education programs for both new medical students and residents, as well as established physicians.

According to one example embodiment, accordingly, the simulation system provides a dynamic response to treatment moves. Further, according to one example embodiment, the involvement of the primary care physician in its development helps provide that the system reflects the clinical terrain and cognitive challenges associated with primary care practice. In addition, the system according to this embodiment focuses on the outpatient clinical encounter as the primary level of description and interaction. The system thus has a broad therapeutic scope that includes improving the ability of physicians or other clinical personnel (e.g. nurse practitioners) to deal with the effect of oral diabetes medications, effects from referrals and advice to patient, in addition to the effect of prescribed insulin.

Accordingly, as described above, this embodiment of the simulation system provides “expert” feedback at the end of a session in which a simulation is executed. In this regard, in one example embodiment, in an effort to get the physician to think prospectively about their management decisions, projections of the patient's future clinical status are presented graphically by the simulation system at the end of each patient encounter. Because feedback is triggered by drug moves, rather than pre-determined by individual case scenarios, there is the ability to initialize an unlimited number of clinical cases. A physician can be presented with different cases that target needed learning points as determined by physician profiling using administrative and/or survey data. Accordingly, the system provides a learning tool with a strong component of decision support aimed at changing care management and error related behaviors.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

The following publication is herein incorporated by reference to the same extent as if said publication was specifically and individually indicated to be incorporated by reference:

Pradyumna Dutta, et al. “SimCare: A Model for Studying Physician Decisionmaking Activity”, Advances in Patient Safety from Research to Implementation, Vol. 1, Research Findings, Kerm Henrickson et al., published by Agency for Health Research and Quality, Rockville, Md. 20850, AHRQ # 05-021-1, February 2005.

### REFERENCES

1. Mazze R, Strock E, Simonson G, et al., Staged diabetes management: detection and treatment. Minneapolis, Minn.: International Diabetes Center; 2001.
2. Entelos diabetes physiolab. Foster City, Calif.: Entelos, Inc.; 2003.
3. Hedbrant J, Ludvigsson J, Nordenskjold K. Sarimner: a computer model of diabetes physiology for the education of physicians and patients. Diabetes Res Clin Pract 1991;14(2):113-22.
4. Wada D R, Stanski D R, Ebing W F. A PC-based graphical simulator for physiological pharmacokinetic models. Comput Methods Programs Biomed 1995;46: 245-55.
5. Lehmann E D, Deutsch T. A physiological model of glucose-insulin interaction. Proc Ann Conf Engin Med Biol 1991; 1 3(5):2274-5.
6. Biermann E, Mehnert H. DIABLOG: a simulation program of insulin-glucose dynamics for education of diabetes. Comput Methods Programs Biomed 1990;32 (3-4):311-8.
7. Romulus T, Hovorka R, Cavan D, et al. DIAS-NIDDM: a model-based decision support system for insulin dose adjustment in insulin-treated subjects with NIDDM. Comput Methods Programs Biomed 1998; 56:175-92.
8. Brown J B, Russell A, Chan W, et al. The global diabetes model: user-friendly version 3.0. Diabetes Res Clin Pract 2000;50(Suppl. 3):S15-S46.
9. Eddy D M, Schlessinger L. Archimedes: a trial-validated model of diabetes. Diabetes Care 2003;26(11):3093 (9).
10. Institute for Clinical Systems Integration. Health care guideline: management of type 2 diabetes mellitus. Bloomington Minn.: Institute for Clinical Systems Integration; 2003.
11. American Diabetes Association Professional Practice Committee. 2003 clinical practice guidelines. Diabetes Care 2003;26(Suppl 1):1-116.
12. O'Connor P, Sperl-Hillen J M, Johnson P E, et al. Identification, classification, and frequency of medical errors in outpatient diabetes care. In: Henriksen K, Battles J B, Marks E S, Lewin D I, editors. Advances in patient safety: from research to implementation. Vol. 1, Research findings. AHRQ Publication No. 05-0021-1. Rockville, Md.: Agency for Healthcare Research and Quality; 2005.
13. Ciechanowski P S, Katon W J, Russo J E. Depression and diabetes: impact of depressive symptoms on adherence, function, and costs. Arch Intern Med 2000;160(21):3278-85.
14. Lustman P J, Anderson R J, Freedland K E, et al. Depression and poor glycemic control: a meta-analytic review of the literature. Diabetes Care 2000;23(7): 934-42.
15. Defronzo R. Pharmacologic therapy for type 2 diabetes mellitus. Ann Intern Med 1999;131(4):281-303.
16. Rickheim P L, Weaver T W, Flader J L, et al. Assessment of group versus individual diabetes education: a randomized study. Diabetes Care 2002;25(2):269-74.
17. Kosko B. Fuzzy thinking—the new science of fuzzy logic. New York: Hyperion; 1993.
18. Law A M. Building valid models: how to build valid and credible simulation models. In: Peters B A, Smith J S, Medeiros D J, et al., editors. Proc 33rd Conf Winter Simul; 2001; Washington, D.C.: IEEE Computer Society; 2001 pp. 22-9.
19. Sargent R G. Validation and verification of simulation models. In: Farrington Pa., Nembhard H B, Sturrock D T, et al., editors. Proc 31st Conf Winter Simul: Simulation—a bridge to the future. Phoenix, Ariz.: ACM Press; 1999.
20. Gavard J A, Lustman P J, Clouse R E. Prevalence of depression in adults with diabetes. An epidemiological evaluation. Diabetes Care 1993;16(8):1167-78.
21. Lustman P J, Griffith L S, Clouse R E. Depression in adults with diabetes. Semin Clin Neuropsychiatry 1997;2(1):15-23.

What is claimed is:

1. A method of dynamically simulating a physician assessment and teaching environment for treatment of a chronic illness, comprising:
providing a library of patient cases histories;
selecting a patient case history from said library of patient case histories;
providing a treatment action in response to the particular patient case history selected; and
providing a projection of the patient's future clinical status based upon said treatment action provided.

2. The method as defined in claim 1, wherein said projection is a graphical representation of the patient's future clinical status.

3. The method as defined in claim 1, wherein the chronic illness is at least one of diabetes, hypertension, hyperlipidemia or depression.

4. The method as defined in claim 1, wherein said projection is provided at least out to 180 days.

5. The method as defined in claim 1, including providing an evaluation of said treatment action provided.

6. The method as defined in claim 1, including providing suggestions for future treatment actions.

7. The method as defined in claim 1, wherein said patient case history includes both physiological and psychosocial patient responses.

8. The method as defined in claim 1, wherein said projection of the patient's future clinical status includes both cumulative and incremental effects of said treatment action.

9. The method as defined in claim 1, wherein said projection of the patient's future clinical status includes the attenuation effects of said treatment action over time on the patient's physiology.
